(19) United States
(12) Patent Application Publication
(10) Pub. No.: US 2016/0179605 A1
(43) Pub. Date: Jun. 23, 2016

(54) MACHINE AND METHOD FOR DIAGNOSING A MACHINE

(71) Applicant: J.G. Weisser Sohne GmbH & Co. KG, St. Georgen (DE)

(72) Inventor: Thorsten Rettich, Konigsfeld (DE)

(73) Assignee: J.G. Weisser Sohne GmbH & Co. KG, St. Georgen (DE)

(21) Appl. No.: 14/910,499

(22) PCT Filed: Aug. 21, 2014
(86) PCT No.: PCT/EP2014/067850

§ 371 Date: Feb. 5, 2016

(30) Foreign Application Priority Data
Aug. 22, 2013 (DE) 10 2013 014 112.5

(51) Int. Cl. G06F 11/07

(52) U.S. Cl. CPC G06F 11/0769; G06F 11/0721

(57) ABSTRACT

The invention relates to a machine (1) comprising an output (3) that is controlled by an error detection and/or information unit (2). According to the invention, the output information codes (7) are converted to control commands (6) with the aid of a control unit (5), by which commands pictorial information associated with the respective information code (7) is output by an output unit (4).

### BACKGROUND

The invention relates to a machine, particularly a machine tool, having an error recognition and/or information unit and at least one output, wherein the error recognition and/or information unit is set up to output an information code at the output on the occurrence of an error or other information requirement during operation of the machine.

Machines of this kind are known and are used in production installations in order to allow or facilitate error recognition for machines during operation. In this context, it is known that in the event of an error or other information requirement the machine provides at the output a numerical code that the user needs to translate into an error description and/or action instruction in a handbook. Since the machines are very complex and have a wealth of functions, these error descriptions and action instructions normally fill several volumes of a handbook. It has become customary for machines, for example component fitting machines, joining machines or machine tools such as reshaping machines, lathes, grinding machines, milling machines or other machines for cutting and/or non-cutting machining of workpieces, to be monitored in production installations by operators, with one operator monitoring multiple machines. Frequently, it is desirable to allow monitoring of this kind by semi-skilled personnel too.

The invention additionally relates to a method for diagnosis, particularly error diagnosis, for a machine, particularly a machine tool, wherein an information code is automatically generated on the occurrence of an error or other information requirement.

### SUMMARY

The invention is based on the object of simplifying the involvement for monitoring the operation of machines and of reducing the demands on required personnel for operating the machines.

The invention achieves this object by providing the features. In particular, for a machine of the type described at the outset, it is therefore provided that an output unit is produced that is set up to output a prescribed number of pictographic and/or audible information items, that an actuation unit is set up to actuate the output unit to output a desired pictographic and/or audible information item from the prescribed number of pictographic and/or audible information items on the basis of an actuation command, that an association between the information codes and actuation commands is provided in a database that can be read by the actuation unit and that the actuation unit is set up to read an information code from the output and to execute an actuation command associated with a read information code. In this case, it is advantageous that there is the possibility of reducing the wealth of information for error recognition. By stipulating a prescribed number of pictographic information items that are actually possible, it is possible for the error recognition and error handling and/or a reaction to information generated by a machine to be performed on the machine even by personnel who have relatively low qualifications. In many cases, a detailed understanding of the internal functional sequence of the machine is no longer necessary. Instead, it is sufficient, for many cases, to internalize action instructions that pertain to the output pictographic information items. The use of pictographic information items in contrast to written instructions affords the advantage that a user can derive the associated action instruction himself, regardless of language, just from the pictographic symbol. By way of example, the information code may be an error code or another pointer, for example a maintenance pointer. The output may therefore be an error output or may at least be able to be used as such. In this case, the output unit may be in the form of a display unit if pictographic information items are output. The output unit may also be set up to output audible signals, however.

The pictographic symbols may be formed by a characteristic shaping and/or coloration. By way of example, it is possible to use color areas or shapes that, in a highly simplified form, denote an activity, a tool belonging to or required for an activity and/or a portion of a machine that belongs to an activity, or combinations of these. The pictographic information items may also be represented in a form that is coded by dot and/or bar patterns, for example in the form of a binary coding in the manner of the binary coding for binary clock displays or in the form of a dot pattern for the spots on a dice.

By way of example, provision may be made for the output unit to have a display. Hence, the output unit can be produced as a display unit. It is advantageous in this case that great flexibility is provided for displaying a wide variety of pictographic information items in the form of pictographic symbols. Hence, a multiplicity of pictographic information items can be displayed in a small space, with the respectively displayed pictographic information items, for example a symbol or a plurality of symbols, being able to be display able, and being able to be displayed, in a manner that fills or takes advantage of the display unit.

Alternatively or additionally, provision may be made for the output unit to have a number of luminous fields that each reproduce a pictographic information item. Hence, the output unit can be produced as a display unit. It is advantageous in this case that the pictographic information items are each associated with a luminous field that can be activated by switching on. The user can therefore recognize what pictographic information item is involved even remotely at the physical position of the respectively lit luminous field. This allows the user, who is responsible for monitoring a plurality of machines, for example, to make preparations for the necessary action measures even remotely.

In one embodiment of the invention, provision may be made for the luminous fields of the output unit to be in flat form. It is advantageous in this case that a space-saving output unit is provided that can be fitted to a housing portion of the machine, for example.

Alternatively or additionally, provision may be made for the luminous fields of the output unit to radiate in a full circle. It is advantageous in this case that recognition of the respectively displayed pictographic information item is possible from different directions. Hence, a user who is responsible for monitoring can read the pictographic information item remotely from his current position.

By way of example, the aforementioned luminous fields may be embodied such that the pictographic information item to be output is printed or permanently produced in another way in order to allow the pictographic information item to be displayed when the associated luminous field is illuminated. The luminous fields may alternatively or additionally be in the form of color areas in different colors.

In one embodiment of the invention, provision may be made for the output unit to be in the form of a shadow board having at least one tool or spare part holder and a signaling element associated with the tool or spare part holder. It is advantageous in this case that the pictographic information item, which is displayed in the form of an activated signaling element pertaining to the respective contour of the tool or spare part, additionally provides the associated tool for the action measure or the associated spare part for this action measure in response to the recognized error. In this context, a shadow board is understood to mean an arrangement of holders for tools and/or spare parts in which the respective holders have such contours as denote the respective tool or spare part that is to be held when filled correctly as explicitly as possible for the user. In comparison with other organization principles, a shadow board therefore has the advantage that correct filling of the shadow board can be recognized just from the fact that the respective tools and/or spare parts placed into the holders match the contours linked to the holders. The use of a shadow board supports the user process for the machine, since the user can recognize the correct tool or spare part for correcting the displayed error from the displayed pictographic information item, that is to say the contour of a holder that is displayed by means of the signaling element.

In one embodiment of the invention, provision may be made for the database to have at least one actuation command that can be used to output at least two separately outputtable, in particular display able, pictographic and/or audible information items on the output unit, particularly the display unit, simultaneously. It is advantageous in this case that this allows the conveyance of a meaning that is simple to grasp, in particular that can be grasped regardless of language. This allows units of meaning to be compiled from elementary commands, the content of which is comprehensible even to users who have only little understanding of the actual technical sequence of a machine. By way of example, this allows the information about an imminent oil change in a particular portion of the machine to be output by virtue of a pictographic information item for “oil change” and a particular pictographic information item for the relevant portion on the machine being displayed. It is also possible for pictographic information items that refer to a particular portion of the machine, for example, to be outputtable in combination with audible information items, for example for an imminent oil and/or tool change.

In this case or in the case of a further exemplary embodiment, provision may be made for at least one actuation command to be provided in a manner compiled from at least two elementary commands that can each be used to output a pictographic and/or audible information item on the output unit. It is advantageous in this case that the aforementioned composition of a more complex meaning can be stored in the database. By way of example, elementary commands may be the aforementioned oil change or even a tool change or cleaning of a waste chamber or refilling of a chamber with consumables. Other elementary commands can denote machine parts or provide other clarification of what addition is meant to apply for an output elementary command.

In one embodiment of the invention, provision may be made for a log device to be present that can be used to record the pictographic and/or audible information items that are output in one period. It is advantageous in this case that inspection of the use of the machine is possible. In comparison with the mere recording of information codes that are output at the output, the recording of the output or displayed pictographic and/or acoustic information items affords the advantage that it is possible to check a conversion of the complex information codes into the pictographic and/or audible information items by means of inspection of the recording. This allows erroneous links in the database to be identified and removed, for example.

In one embodiment of the invention, provision may be made for the output unit, particularly the display unit, to be mounted immovably on the machine or to be set up immovably next to the machine. It is advantageous in this case that it is possible to ensure that the output unit can always be read from a preferred position, for example the regular whereabouts of the user. Hence, in comparison with the swivelable arrangement of control panels and the like that has been customary to date for operation in situ, the fixed, non-swivelable arrangement of the output unit affords the advantage that the output unit is not by chance unreadable in the event of an error due to its having been unintentionally or inadvertently swiveled into an unreadable position. Valuable time up to error recognition and up to the beginning of error correction can therefore be saved.

To achieve the stated object, the invention provides that a method of the type described at the outset involves the information code being automatically converted into an actuation command for an actuation unit using an association between information codes and actuation commands that is kept in an electronically readable database, and the actuation unit using the actuation command to output, particularly to display, a pictographic information item and/or audible information item from a prescribed number of pictographic and/or audible information items. It is advantageous in this case that the complexity of the possible information codes is reduced to an easily comprehensible, in particular comprehensible regardless of language, number of pictographic and/or audible information items. It is therefore possible to dispense with in-depth technical understanding of the machines for recognition of important actions in response to output errors or other pointers.

In one embodiment of the invention, provision may be made for the pictographic information item to be output, particularly displayed, by actuating a display. It is advantageous in this case that great design latitude is available for the design of the pictographic information items. Alternatively or additionally, provision may be made for the pictographic information item to be displayed by activating at least one luminous field that represents the pictographic information item. This makes it possible to achieve a high recognition value for the displayed pictographic information item. The combination of the fixed position of a luminous field with the fixed outer design of the luminous field by virtue of the pictographic information item allows a quick reminder of the true semantic content of the displayed pictographic information item and the correct choice of the associated action instructions.

Alternatively or additionally, the output unit may be set up to output audible information items, particularly sound signals. By way of example, the output unit may have a tone generator, and/or a loudspeaker.

In one embodiment of the invention, provision may be made for the pictographic information item to be output by activating at least one signaling element of a shadow board. It is advantageous in this case that the pictographic information item can be displayed by the contour of the portion of the shadow board that is denoted by the signaling element. It is also advantageous that the display simultaneously also refers to the correct tool or the correct spare part for executing the associated action instructions. Hence, a user can use the output pictographic and/or audible information item to immediately inspect whether the action instructions may be correct or whether they have been memorized incorrectly. A risk of confusion between the associated action instructions can therefore be decreased.

In one embodiment of the invention, provision may be made for the actuation command to be compiled from elementary commands that are used to output individual pictographic and/or audible information items. It is advantageous in this case that a rudimentary image and/or sound language can be used in which components of the pictographic and/or audible information items that are each associated with the elementary commands carry a semantic meaning of their own. By way of example, elementary commands of this kind may be an oil change, a tool change, cleaning of a machine part, the provision of new consumables, a disruption in the flow of materials or generally the statement that it is time for a particular action. By way of example, further elementary commands can denote particular machine parts for which the respective other elementary command is meant to apply. It is also possible for pictographic and/or audible information items to be compiled from more than two elementary commands.

It is particularly beneficial if the actuation commands used are concomitantly logged or electronically recorded. This allows an inspection of whether pictographic and/or audible information items are ambiguous or information codes are incorrectly assigned, for example when an incorrect action instruction is executed for an output information code.

In the case of the invention, that is to say in the case of the method according to the invention and/or in the case of the machine according to the invention, the machine may be in the form of a machine tool, particularly a lathe, a grinding machine, a milling machine and/or another machine for the cutting and/or non-cutting machining of workpieces, for example.

### BRIEF DESCRIPTION OF THE DRAWINGS

The invention will now be described in more detail using an exemplary embodiment but is not limited to this exemplary embodiment. Further exemplary embodiments will emerge through a combination of the features of individual or multiple claims with one another or with individual or multiple features of the exemplary embodiment.

The single

FIG. 1 shows a schematic illustration of a machine according to the invention to explain the method according to the invention.

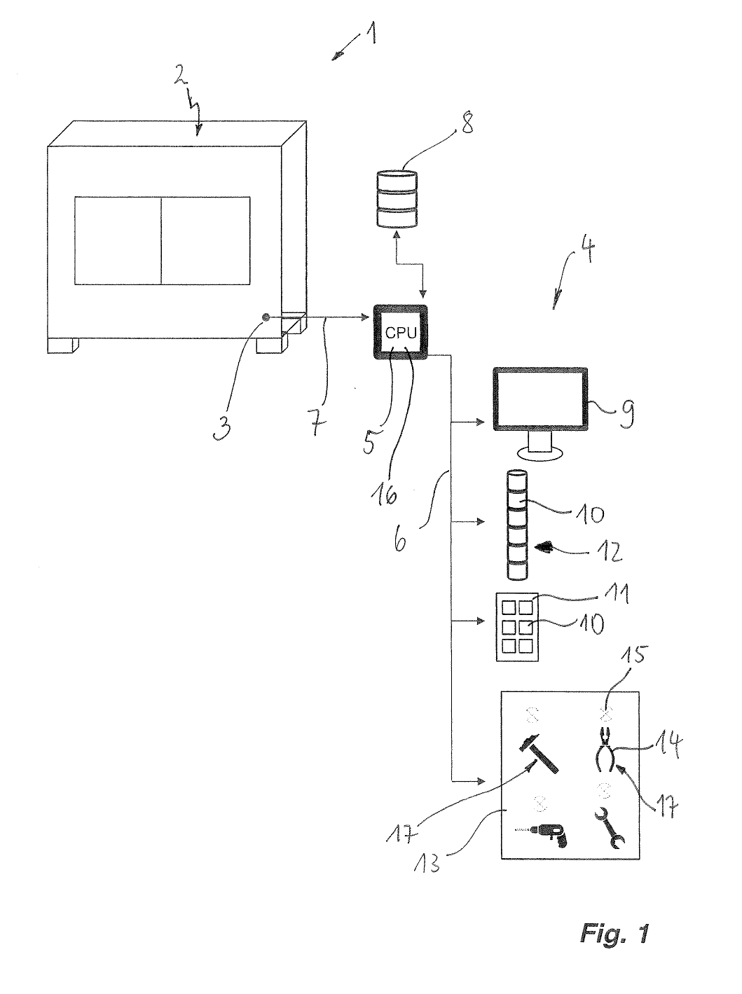

### DETAILED DESCRIPTION OF THE PREFERRED EMBODIMENTS

A machine that is denoted as a whole by 1 has an inherently known error recognition and/or information unit 2, which is not shown further, that can be used to automatically recognize errors in the sequence of the operation of the machine 1 in a manner that is known per se. The machine 1 is shown as a machine tool for the purposes of explaining the invention. Details of the machine 1 are not shown in more detail in order to simplify the illustration, and are known from commercially available machines. In further exemplary embodiments, the machine is set up for other workpiece machining and/or workpiece processing steps, for example joining, particularly adhesive bonding and/or welding, component fitting, sorting, assembly and/or other handling.

By way of example, the machine 1 may be a lathe, a grinding machine, a milling machine, or set up in another way for cutting and/or non-cutting machining of a workpiece.

The error recognition and/or information unit 2 is connected to an output 3 to which an information code, for example an error code, is applied when an error or another pointer, for example a maintenance pointer, is recognized during operation of the machine 1.

The machine 1 has an output unit 4, which is described even more accurately, produced on it that can be used to output a prescribed number of pictographic and/or audible information items.

An actuation unit 5 generates actuation commands 6 on the basis of information codes 7 that are applied to the output 3.

To this end, the actuation unit 5 reads the output 3 at recurrent times or even continuously and accesses a database 8 in order to convert the respectively read information code 7 into an associated actuation command 6.

For this purpose, the database 8 stores an association between outputtable information codes 7 and associated actuation commands 6.

The sum total of the stored associations provides a prescribed number of pictographic and/or audible information items that can actually be output.

The output unit 4 may be in the form of a display unit and, by way of example, may have a display 9 on which the pictographic information item, which is not shown further in this case, can be displayed. In this case, the actuation command 6 comprises, in a manner which is known per se, the measures for appropriate actuation of the output of the display 9. The display 9 may be produced on a smartphone, a tablet PC, a preferably portable PC, a smart watch, smart glasses, a smart reading and/or visual aid and/or another mobile computation unit.

Alternatively or additionally, the output unit 4 may have luminous fields 10, each luminous field 10 being associated with a respective outputtable pictographic information item by virtue of the pictographic information item being permanently reproduced on the luminous field 10. The output is made in the form of display through activation, that is to say switching on, for example, of the luminous fields 10.

In this case, the luminous fields 10 may be in the form of flat luminous fields 10 on a panel 11 or may be produced on a luminous column 12 for the purpose of radiation in a full circle. In further exemplary embodiments, other arrangements and embodiments of the luminous fields 10, including other shapes, are implemented.

The output unit 4 may also have a shadow board 13, with the pictographic information items being displayed by contours of the respective associated tools 14 or spare parts. These contours each define a tool or spare part holder 17 for the respective tool 14 or spare part. For the purpose of display, the relevant signaling element 15, for example an LED or another illuminant or a tone generator, is activated. The tool or spare part holder 17 pertaining to the activated signaling element 15 is the pictographic information item that is displayed by the activation.

The database 8 stores actuation commands that can be used to output not only a single pictographic and/or audible information item but also a plurality of pictographic information items simultaneously. By way of example, actuation commands 6 may be stored that can be used to activate a plurality of luminous fields 10 simultaneously and/or that can be used to output additional sound signals.

In this way, the actuation commands 6 can be compiled from elementary commands that each relate to a pictographic and/or audible information item and that, by way of example, lead to the activation of a single luminous field 10 or to the output of a sound sequence or at least a chord.

The actuation unit 5 contains a log device that is used to record the output pictographic and/or audible information items in the form of the transmitted actuation commands 6.

In this way, it is possible to comprehend which information item has been output in each case. Hence, it is possible to perform an inspection of the user instructions for the users in response to the respective pictographic and/or audible information item.

In further exemplary embodiments, the output unit 4 may alternatively or additionally be set up to output audible information items, for example stipulated sound sequences and/or chords. To this end, the output unit 4 can have a tone generator that is connected to a loudspeaker.

The aforementioned output units 4 are each immovably, that is to say particularly non-swivelably, mounted on the machine 1 or immovably set up next to the machine 1. Hence, the output unit 4 cannot be taken out of the field of view of the user by unintentional or inadvertent swiveling.

During operation, the information code applied to the output 3 is therefore automatically recognized by means of cyclic or even continuous reading and automatically converted into an actuation command 6 by means of the database 8. This conversion is carried out by the actuation unit 5, which accesses the database 8 and may have a CPU.

The actuation command 6 is then output to the respectively present output unit 4 so as there to output the pictographic and/or audible information item that is denoted by the actuation command 6.

This can be accomplished by actuating the display 9 or by activating the associated luminous field 10 and/or by activating the associated signaling element 15.

The actuation commands 6 can be compiled from elementary commands such that a plurality of pictographic and/or audible information items, which can be output or displayed independently of one another, are output simultaneously. To this end, the actuation command 6 contains commands that lead to the activation of a plurality of luminous fields 10 or a plurality of signaling elements 15 simultaneously.

The respectively output actuation commands 6 are recorded in the actuation unit 5 in a log device 16.

In further exemplary embodiments, the output unit 4 may be in the form of a combination of the examples shown, for example in the form of a combination of a display 9 and/or a luminous column 12 with a shadow board 13.

In the case of the machine 1 with an output 3 that is actuated by an error recognition and/or information unit 2, it is proposed that the output information codes 7 be converted by means of an actuation unit 5 into actuation commands 6 that output a pictographic and/or audible information item associated with the respective information code 7 on an output unit 4.

1. A machine (1), comprising an error recognition/information unit (2) and at least one output (3), the error recognition/information unit (2) is configured to output an information code (7) at the output (3) on occurrence of an error or other information requirement during operation of the machine (1), an output unit (4) configured to output a prescribed number of pictographic, audible, or pictographic and audible information items, an actuation unit (5) configured to actuate the output unit (4) to output a desired one of the pictographics audible, or pictographic and audible information item from the prescribed number of pictographic, audible, or pictographic and audible information items on the basis of an actuation command (6), an association between the information codes (7) and actuation commands (6) is provided in a database (8) that is readable by the actuation unit (5), and the actuation unit (5) is configured to read one of the information codes (7) from the output (3) and to execute an actuation command (6) associated with a read one of the information codes (7).

2. The machine (1) as claimed in claim 1, wherein the output unit (4) has a display (9).

3. The machine (1) as claimed in claim 1, wherein the output unit (4) has a number of luminous fields (10) that each reproduce a pictographic information item.

4. The machine (1) as claimed in claim 3, wherein the luminous fields (10) of the output unit (4) are in flat form or radiate in a full circle.

5. The machine (1) as claimed in claim 1, wherein the output unit (4) is a shadow board (13) having at least one tool or spare part holder (17) and a signaling element (15) associated with the tool or spare part holder (17).

6. The machine (1) as claimed in claim 1, wherein the database (8) has at least one actuation command (6) that is usable to output at least two separately outputtable ones of the pictographic, audible, or pictographic and audible information items simultaneously.

7. The machine (1) as claimed in claim 1, wherein at least one of the actuation commands (6) is provided in a manner compiled from at least two elementary commands that are each usable to output one of the pictographic, audible, or pictographic and audible information items on the output unit (4).

8. The machine (1) as claimed in claim 1, further comprising a log device (16) that is usable to record the pictographic, audible, or pictographic and audible information items that are output in one period.

9. The machine (1) as claimed in claim 1, wherein the output unit (4) is mounted immovably on the machine (1) or is set up immovably next to the machine (1).

10. A method for diagnosis for a machine (1), comprising: automatically generating an information code (7) on occurrence of an error or another information requirement, automatically converting the information code (7) into an actuation command (6) for an actuation unit (5) using an association between information codes (7) and actuation commands (6) that is kept in an electronically readable database (8), and the actuation unit (5) using the actuation command (6) to output a pictographic information item from a prescribed number of pictographic, audible or pictographic and audible information items.

11. The method as claimed in claim 10, wherein the pictographic, audible, or pictographic and audible information item is output by actuating a display (9) or activating at least one luminous field (10) that represents the pictographic information item, or the pictographic, audible, or pictographic and audible information item is output by activating at least one signaling element (15).

12. The method as claimed in claim 10, further comprising compiling the actuation command (6) from elementary commands that are used to output individual ones of the pictographic, audible, or pictographic and audible information items.

13. The method as claimed in claim 10, further comprising recording the actuation commands (6) used.
